(19) United States
(12) Patent Application Publication
(10) Pub. No.: US 2010/0078115 A1
(43) Pub. Date: Apr. 1, 2010

(54) Use of a Device for Torsional Ultrasonic Welding

(75) Inventor: Georg Lang, Tiefenstein (DE)

Correspondence Address: SHOEMAKER AND MATTARE, LTD, 10 POST OFFICE ROAD - SUITE 100, SILVER SPRING, MD, 20910, US

(73) Assignee: TELSONIC HOLDING AG, Bronschhofen (CH)

(21) Appl. No.: 12/517,748

(22) PCT Filed: Dec. 5, 2007
(86) PCT No.: PCT/EP07/63350

§ 371 Date: Jun. 4, 2009

(30) Foreign Application Priority Data
Dec. 7, 2006 (EP) 06125550.1

(51) Int. Cl. B29C 65/08; B28B 1/087

(52) U.S. Cl. 156/73.1; 156/580.1; 264/71

(57) ABSTRACT

The invention relates to the use of a device for torsional ultrasonic welding for joining parts (3, 3′), at least part of which are made completely, or partially, of plastic. The device is also used to join parts, of which at least part comprises a shock-sensitive component, or of which at least one part is associated with a shock-sensitive component.

The invention relates to the use of a device for torsional ultrasonic welding for welding plastic parts and parts with shock-sensitive components and to a process for welding plastic parts and shock-sensitive parts and to a device for torsional ultrasonic welding with the features of the independent claims.

It is known that ultrasound triggers a series of mechanical, chemical and biological effects. EP 0962261 A1, for example, describes a device for treating fluids with a torsion sonotrode, which can be made to vibrate by an ultrasound vibration generator. Systems for the ultrasonic welding of metals with torsional excitation or torsion sonotrodes are also known. Such a device is mentioned, for example, in the book by Wilhelm Lehfeld: Ultraschall/ISBN 3-8023-0060-2, page 91.

DE 334 2619 A1 describes a process for the ultrasonic welding of thermoplastic materials, in particular for the welding of automobile bumpers, with a longitudinally oscillating sonotrode.

However, conventional ultrasonic welding with vibrations directed in the direction of the workpiece has certain disadvantages: sensitive structures and components may be damaged or destroyed by the vibrations. There is a great risk of neighboring, already welded joints or thin connecting webs and pins being damaged by the ultrasonic welding. Conventional ultrasonic welding, i.e. with a sonotrode oscillating in the longitudinal direction, proves to be particularly problematic for the welding of housings or parts that are intended for receiving sensitive electronics. For example, the amplitude necessary for the sealed welding of polyamide plastic housings is highly likely to destroy the electronics. Therefore, those skilled in the art refrain from using ultrasonic welding for parts with sensitive electronics and mechanics. Since it is generally not possible for the sensitive electronics to be subsequently checked in the welded housing, and certain secondary damage to the electronics may only become evident after years, alternative welding or adhesive bonding processes are used instead when connecting parts with a sensitive content, such as sensors for automotive engineering for example. For example, sensitive parts are connected by means of laser or friction welding. However, these processes have the disadvantage that the welding operation takes a long time and/or that the parts to be connected are subjected to great thermal loads. Moreover, laser welding is unsuitable for glass fiber reinforced plastics because of the stray light occurring. Laser welding of two plastic parts is also restricted to parts where one is laser-transparent and the other is laser-absorbent. It has been found that adhesively bonded connections on plastic housings for sensors cannot withstand the loads of alternating climate tests, and the housing with the sensitive electronics is no longer sealed.

A further disadvantage also occurs when welding parts with very thin walls, such as films or membranes. The longitudinal ultrasonic waves have the tendency to tear the sensitive membranes, so that a hole is created in the middle (membrane effect). Thermal processes are similarly critical for parts with thin walls, because the high temperatures may damage the parts.

It is therefore an object of the present invention to avoid the disadvantages of the known art, in particular to provide a process and a device of the type mentioned at the beginning which can connect two parts, particularly comprising a sensitive component or content, in particular in a non-destructive and simple manner, and do not require any great expenditure of time. Moreover, it is intended that the connecting can be performed as inexpensively as possible.

These objects are achieved according to the invention by the use of the device for torsional ultrasonic welding, a process and a device according to the features of the independent claims.

Ultrasound in the frequency range from approximately 15 kHz to 100 kHz, particularly preferably 20 kHz to 30 kHz, has proven to be advantageous for the invention. Typically, a sonotrode may be subjected to a power of up to 10 kW.

For the connecting of parts of which at least one consists entirely or partially of plastic, according to the invention a device for torsional ultrasonic welding is used. Torsional is understood here as meaning an oscillation of a sonotrode about its longitudinal axis, that is to say the sonotrode performs a torsional movement about a torsion axis which is substantially perpendicular to the plane of the weld to be formed. The torsion axis consequently lies substantially parallel to the axis of the force with which the sonotrode is pressed onto the part.

The advantage is that, with this arrangement, thanks to the use of ultrasonic vibrations, thermal loading of the parts is prevented and the welding time is short in comparison with conventional processes. It has been found, completely surprisingly for a person skilled in the art, that torsional ultrasonic welding is well-suited for the connection of plastic parts and eliminates the disadvantages of the devices previously used.

A further aspect of the invention is the use of a device for torsional ultrasonic welding for connecting parts of which at least one contains as a component a part that is shock-sensitive, in particular with respect to longitudinal shocks, or at least one part is associated with a shock-sensitive component. Longitudinal shock is to be understood here as meaning an impulse which acts on the part, in particular in the direction of the torsion axis. Such shocks occur, for example, in the case of longitudinal/linear ultrasonic welding.

One of the parts to be connected may therefore itself be at least partially shock-sensitive or one part is associated with a shock-sensitive part, by for example enclosing it or being coupled to it. It is also conceivable that only the connecting of the parts brings the sensitive component into interaction with the parts and as a result becomes damaged during the connecting. Contrary to the consensus among those skilled in the art that ultrasonic welding must not be used under any circumstances for the welding of sensitive parts, in particular electronic components, torsional ultrasonic welding proves to be particularly advantageous for these purposes. In particular, at most linear vibrations occur thereby that are of no significance. A further advantage is the comparatively low capital expenditure on such a device in comparison with conventional devices. The absence of thermal loading of the parts to be welded proves to be a further advantage. With the use of the torsional ultrasonic welding device, moreover, only simple welding movements are necessary, and these can also be carried out quickly. This allows the device to be advantageously integrated and used in an automatic production line.

The device is used with preference for connecting parts with one of the following sensitive components: an electronic component, such as integrated circuits for example; a gas; a fluid; a fine-mechanical component; a chemical compound, in particular explosives; a substrate for conductor tracks; a treated surface, preferably lacquers, metallizations or coatings; a plastic element with thin walls, preferably a film or a membrane; thin riveted joints; hard and breakable materials, such as glass or silicon for example.

It goes without saying that other sensitive materials are also conceivable. The advantage is the non-destructive handling of the sensitive components during the welding as a result of the absence of longitudinal shocks. This prevents conductor tracks, solder lugs or other electronic parts from becoming detached from a printed circuit board, or the electronic components, such as resistors, transistors or integrated circuits, etc., from being damaged themselves. Fine-mechanical components, such as springs, gear wheels and shafts for example, are also protected from mechanical damage such as bending, canting, slipping from their desired position or from unintended welding (if they are made of plastic).

Treated surfaces may be particularly sensitive: lacquered, metallized or otherwise coated surfaces, such as chromium-plated plastic fittings for example, are particularly sensitive to longitudinal shocks. There is the risk of the coating or metallization becoming detached from the substrate. Torsional ultrasonic welding proves to be particularly advantageous here, since spalling of the coating can be prevented. Torsional ultrasonic welding is also advantageous for parts with sensitive surfaces, such as grained surfaces on the opposite side of the welding, i.e. the anvil side, for example. Conventional ultrasonic welding devices leave undesired impressions behind on such surfaces on the anvil side.

Thin parts such as films or membranes of plastic or metal are particularly sensitive to longitudinal ultrasonic welding, since the thin layers can be easily destroyed by the amplitudes or thermal loading (known as the membrane effect). Torsional ultrasonic welding only subjects the membrane/film to loading under its welding zone. A further advantage is that the films can be welded with greater strength by torsional ultrasound in comparison with conventional welding processes. This is because only interfacial friction occurs, with no undesired notching effect in the welding of films. It is also conceivable to arrange a sonotrode such that it can be displaced in a fully programmable manner on an x-y table. This allows contours to be followed for different films, for example for the production of blister packs.

After welding, the parts preferably form an at least partially closed housing of plastic, for example of polyamide (PA). The advantage of the use according to the invention is that, although visual inspection of the content is not possible as a result of the closed surface, the user has the certainty that no damage can occur by way of mechanical or thermal loading of the sensitive parts. At the same time, however, a welded connection that is durable and sealed is obtained.

The sensitive electronic component is preferably a sensor. For example, it is a sensor for fitting in a vehicle, such as a camshaft sensor or a knock sensor for example. This is subjected to high thermal and mechanical loads during operation. Moreover, the sensor housings must be absolutely watertight. The sensor is therefore advantageously welded in a plastic housing by means of a torsional ultrasonic welding device.

The use of the device for torsional ultrasonic welding for forming a connection between the two parts that is not rotationally symmetrical proves to be particularly advantageous. The parts to be welded therefore do not have to be rotationally symmetrical. Any desired shapes are conceivable. For example, a rectangular cover may be welded onto a rectangular housing, creating a rectangular welded connection. This makes the greatest possible flexibility possible with respect to the geometry of the parts. The invention is also suitable furthermore for welding through interfering media, for example through oil.

The device for torsional ultrasonic welding may alternatively also be used for riveting at least two parts. At least one part has a molding pin, which is transformed into a rivet head by the ultrasonic vibrations. One advantage of this is that very thin webs can be used. Moreover, parts that are sensitive to longitudinal oscillations can also be riveted. It is also possible to produce a number of riveted joints simultaneously with just one sonotrode.

A further aspect of the use of a device for torsional ultrasonic welding is the punching out of a film, in particular of plastic. This device according to the invention is therefore also suitable for separating and cutting plastic parts, such as bumpers for example. The torsional oscillations leave the film intact; the membrane effect that occurs in the case of conventional ultrasonic welding devices and leads to destruction of the film does not happen. In particular when punching lacquered plastic parts, such as bumpers for example, with the process according to the invention it is also possible for the lacquer layer to be folded over in order that the core material is not visible in the hole.

A further aspect of the invention comprises a process for connecting a first part to at least one second part, at least one of the parts consisting entirely or partially of plastic. For connecting, the first part is subjected to torsional ultrasonic vibrations. This process is particularly advantageous, since the mechanical and thermal loading is much less than in the case of parts that are excited longitudinally, i.e. in a plane perpendicular to the plane of the weld.

Another aspect concerns a process for connecting parts of which at least one contains a shock-sensitive component, or at least one part is associated with a shock-sensitive component. For this purpose, one part is subjected to ultrasonic vibrations. Associated means that the sensitive component does not necessarily have to be connected to the part to be welded, but that a part is in such a relationship with the sensitive component that the welding operation can have an effect on the component. The association may, for example, be that a part encloses a sensitive content, for example even only after welding, or that a part rests on a sensitive component or is fastened to it.

The sensitive component preferably comprises an electronic component, a gas, a fluid, a fine-mechanical component, a chemical compound, in particular explosives, a substrate for conductor tracks, treated surfaces, preferably lacquers, metallization or coatings, a plastic element with thin walls, preferably a film or a membrane, thin riveted joints or hard and breakable materials such as glass or silicon. The invention may also be used for embedding bushes or similar parts. The invention can be used particularly advantageously for welding in spouts in the packaging industry. Inner parts, such as films, or else the closure mechanism in the spout, cannot be adversely affected.

Parts which, after connecting, form an at least partially closed housing of plastic are welded particularly preferably. The housing parts used are preferably of polyamide (PA). The advantage of this process is that sensitive components can be hermetically sealed in a housing. The invention also allows the welding of different materials, also including materials that require a high amplitude.

In an advantageous way, a sensor for fitting in a vehicle is used as the sensitive electronic component.

With preference, parts that are not rotationally symmetrical can also be connected to one another. Consequently, in principle any desired shapes can be welded to one another.

A further aspect concerns a process for riveting a first molding comprising at least one molding pin, in particular of plastic, and a second molding, in particular of plastic. For this purpose, the molding pin is subjected to torsional ultrasonic vibrations in such a way as to produce a deformation of the molding pin into a rivet head and connect the two moldings. The advantage is that, as a result, parts with sensitive surfaces and/or particularly filigree molding pins can also be riveted.

It has surprisingly been found that, unlike in the case of conventional longitudinal ultrasonic welding of plastic, in which both plastic parts to be welded must co-vibrate in order to form a weld, in the case of torsional ultrasonic welding the part to be welded should be held in a molding holder with as little play as possible. By contrast with this, the part in the anvil in the case of the known ultrasonic welding should be mounted with play in the molding holder. The part or molding to be connected that is not directly subjected to oscillations is preferably fixed or clamped relatively with respect to the direction of oscillation of the sonotrode in a molding holder. This prevents it from undergoing torsional movements. The molding holder preferably engages the weld directly. The molding holder is preferably formed in such a way that the torsional movement is not transferred to the part that is not directly subjected to oscillations. For example, in the case of parts that are not rotationally symmetrical, a hard casting mold is preferably created, for example from epoxy resin, as a molding holder, in which the part to be welded is partially cast. A molding holder milled into metal is also particularly suitable. The mass and strength of the molding holder is preferably great enough to prevent co-vibration of the molding holder and the part clamped in it. A rough surface of the molding holder, so that great friction between the molding holder and the clamped molding is obtained, also proves to be advantageous.

A further aspect of the invention comprises a device for torsional ultrasonic welding with a generator, at least one converter and a torsional oscillator for subjecting a sonotrode to torsional oscillations and a molding holder for holding a molding. The molding holder is formed in such a way that a molding can be fixed with virtually no play in relation to the directions of movement of the sonotrode torsionally and longitudinally in the molding holder, while the other molding, which is subjected to oscillations, can co-vibrate with the oscillations. The fixing takes place in such a way that the one part is firmly clamped such that a welded connection can be produced by the torsional oscillation. The mass of the molding holder is preferably chosen such that, on account of its mass inertia, the molding holder cannot be made to vibrate by the sonotrode. This arrangement is particularly advantageous because good welding between the two moldings can be achieved as a result.

The molding holder preferably comprises a casting, for example from two-component epoxy resin, and/or an adjustable, firmly clamping mechanical holder, which may be made from metal. The molding holder preferably has a hard and rough surface, which increases the friction with respect to the molding when the latter is clamped. Other, less deformable materials are also conceivable. Important for the success of the welding is the property that the molding holder can firmly clamp the molding, so that it cannot be made to vibrate with oscillations triggered by the sonotrode. A casting is particularly advantageous because this allows a molding holder of an exact fit, in which the molding can be placed with zero play, to be formed.

The molding preferably can be fixed in the molding holder in such a way that the molding holder directly borders a plane of a weld of the parts to be connected, or protrudes at least partially beyond the plane of the weld. The clamping or fixing of the lower part must therefore take place as close as possible to the weld. Otherwise, the torsional effect is lost in the lower part and does not occur in the weld. This fastening has the advantage that even soft and/or elastic materials, in particular all thermoplastics and also some thermosets, can be firmly clamped along the weld without torsional oscillations being transferred to the fixed part.

A further aspect concerns a device for torsional ultrasonic welding for the fine stamping and/or fine lapping of a molding, in particular a high-precision injection molding, and a corresponding process. The molding is preferably a high-precision micro injection molding of metal, such as for example the needle of an injection valve for internal combustion engines. The precision of the injection molding is not sufficient, so that it is necessary in particular for the seat and the sealing of the nozzle needle for the injection valve to be laboriously reworked by fine stamping and/or fine lapping. For this purpose, the surface of the part to be worked is subjected to torsional oscillations, whereby a transformation of the surface occurs. The use or the process has the advantage that precise and inexpensive working of the surface of the sensitive injection molding can be achieved as a result, without the filigree injection molding being damaged.

Further details and advantages of the invention emerge from the following description of the exemplary embodiments and from the drawings, in which:

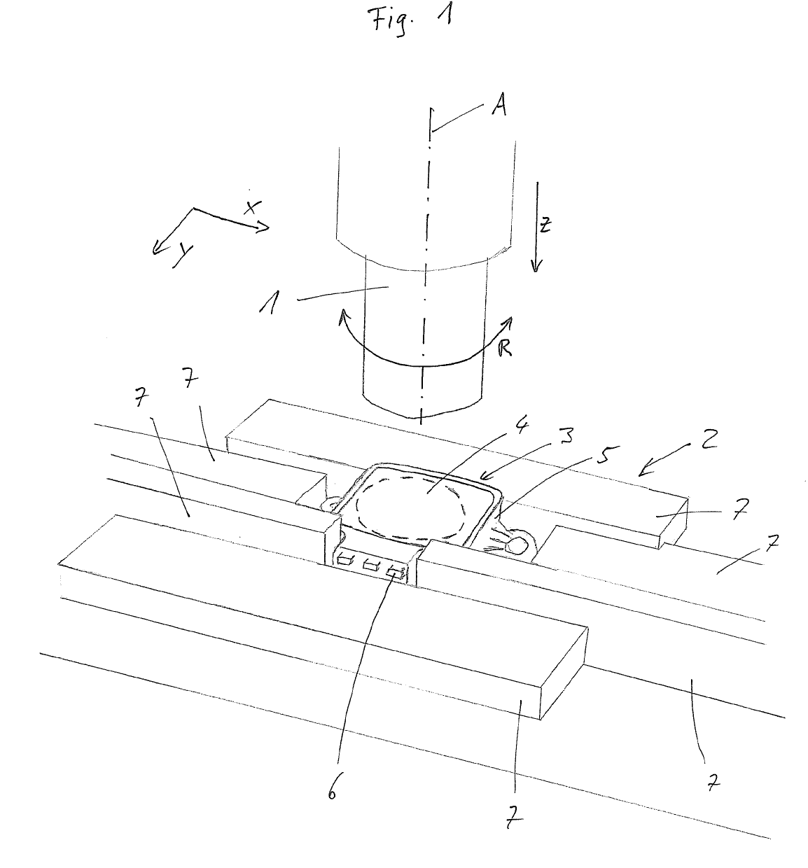

FIG. 1 shows a perspective representation of a part of a sonotrode and of a molding holder with a clamped molding,

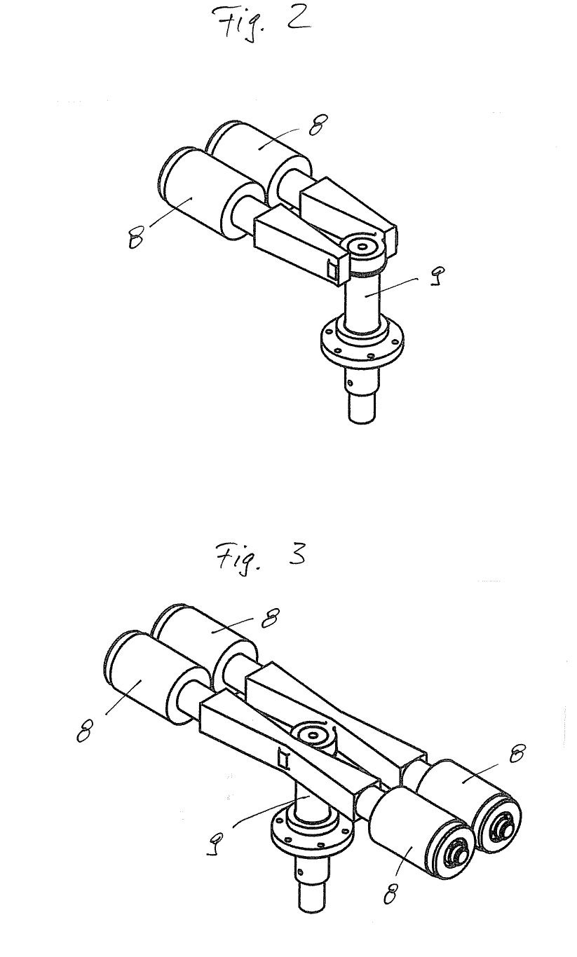

FIG. 2 shows a perspective view of a first exemplary embodiment of a device for torsional ultrasonic welding,

FIG. 3 shows a perspective view of a second exemplary embodiment of a device for torsional ultrasonic welding,

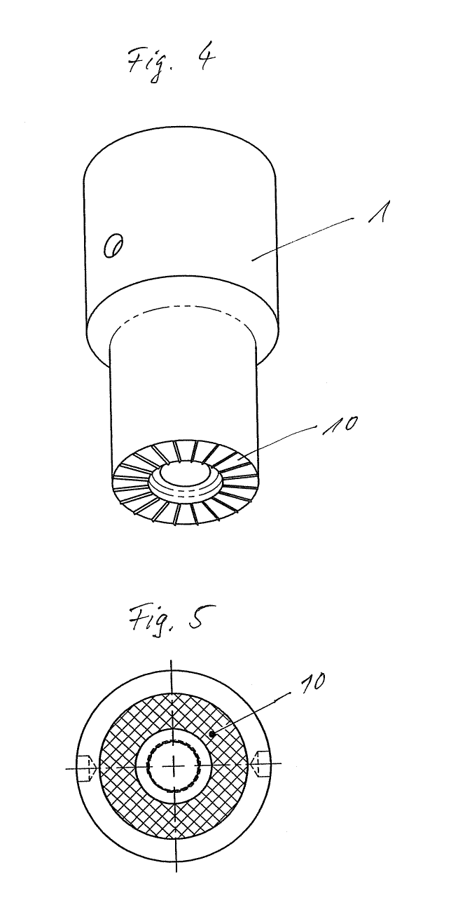

FIG. 4 shows a perspective view of a detail of a first exemplary embodiment of a sonotrode,

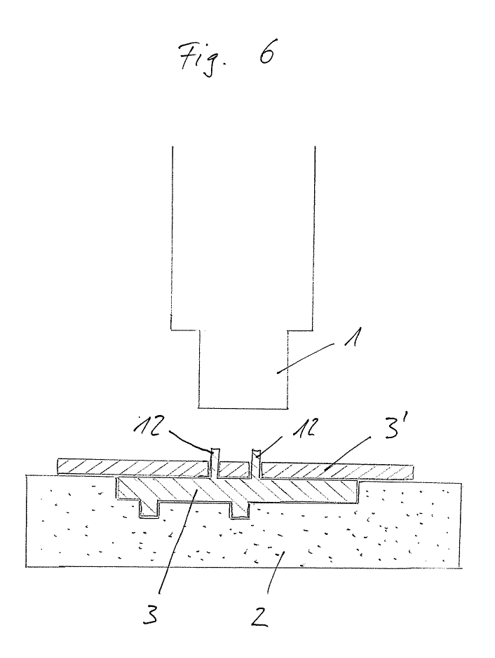

FIG. 5 shows a plan view of a second exemplary embodiment of a sonotrode,

FIG. 6 shows a schematic crosssection through a sonotrode and a molding holder with two moldings to be riveted.

FIG. 1 shows a sonotrode 1, which is arranged over a molding holder 2. The sonotrode belongs to a device for torsional ultrasonic welding, represented for example in FIG. 2. The sonotrode 1 can be moved up and down in a Z direction by means of a lifting and lowering device, which is not represented here. Such lifting and lowering devices are known to a person skilled in the art and serve the purpose of applying a pressing force to a molding 3 in the Z direction. The sonotrode 1 can be subjected to torsional ultrasonic vibrations, so that the sonotrode 1 can perform a torsional oscillation R about the torsion axis A.

Here, the molding 3 comprises a rectangular cover 4, which is to be welded to a housing 5 of a sensor. Both parts 4, 5 are of polyamide. Laterally, the housing 5 has connection contacts 6 of the electronics of a sensor.

The molding holder 2 comprises a number of metal blocks 7, which firmly clamp the housing 5. As a result, the housing is clamped without any play, in particular in the Z direction and in an X-Y plane, and the housing 5 particularly cannot perform any torsional movements about the axis A. If the sonotrode is then lowered toward the cover 4, a local frictional engagement is produced between the surface of the sonotrade 1 and the surface of the cover 4 along a line, indicated by the dashed line, so that the torsional oscillations of the sonotrode 1 are transferred to the cover 4. In order that the oscillations cannot be transferred to the housing 5, the metal blocks are of a solid form and are stably connected to one another or to a workbench, for example bolted. As a result of the inertia of the solid metal blocks 7, a transfer of the torsional oscillations to the molding holder 2 or to the clamped housing is prevented. The clamping of the housing 5 is improved by the rough surface of the metal blocks 7 on their inner side, facing the molding. The cover 4 rests more or less loosely on the housing 5 and can co-vibrate with the torsional oscillations and transfer the oscillations of the sonotrode to the housing 5 in the Z direction.

The edges of the metal blocks 7 that are the upper edges in FIG. 1 lie partially flush with the weld between the cover 4 and the housing 5.

The metal blocks 7 also partially protrude beyond the plane of the weld. This ensures that the housing 5 lies securely in the molding holder and can absorb the torsional oscillations and a welded connection between the cover and housing can be produced in the first place.

FIG. 2 shows a typical device for torsional ultrasonic welding, the molding holder not being represented. The device has two converters 8 arranged in parallel, which are connected to a common torsional oscillator 9. Alternatively, it is also possible for only one, single converter 8 to be provided, instead of two. The torsional oscillator 9 is connected to the sonotrode 1. The two converters 8 are controlled in such a way that the oscillations of the converters are transferred to the torsional oscillator 9 in an alternating cycle.

FIG. 3 presents a further form of a torsional ultrasonic welding device for the use according to the invention. Instead of two converters 8, as in FIG. 2, the device has four converters 8, which excite the torsional oscillator 9. As a result, the device has an increased output in comparison with the device represented in FIG. 2.

FIG. 4 shows a single sonotrode 1. The surface 10 that can be placed onto the part to be welded has the form of an annular disk with a serration. Here the diameter of the sonotrode is around 35 mm. With these depressions, the friction between the molding and the sonotrode is increased.

FIG. 5 shows another configuration of the surface 10 of a sonotrode 1. The surface 10 is grooved in a 90° crosswise manner and has a flank angle of 45°. The depth of the grooving may vary from 0.6 to 0.25 mm. However, other flank and groove angles are also conceivable.

FIG. 6 presents a schematic cross section through a molding holder 2 and a sonotrode 1 for the riveting of two moldings 3, 3′. The molding holder 2 is represented here as hardened epoxy resin, which forms a casting of the lower part of the molding 3. The molding 3 lies in the epoxy resin mold with zero play and has a shape that is not rotationally symmetrical. As a result, the molding 3 lies in the molding holder 2 in such a way that it is prevented from rotating about the torsion axis A. The molding 3 has two molding pins 12, which protrude through two openings in the upper molding 3′ in the direction of the sonotrode 1. For riveting, the sonotrode is lowered onto the molding pins 12 in the Z direction and the molding pins 12 are subjected to torsional ultrasonic vibrations. At the same time, the sonotrode is first pressed onto the molding pins 12 in the Z direction with a force of 300 Newton for around 4.5 seconds, so that said pins are plastified. Then, the force of the sonotrode 1 is increased to 3000 Newton for around 1 second. As a result, the molding pins are deformed and are pressed widthwise, and a play-free connection is produced between the two moldings 3, 3′.

1-21. (canceled)

22. A process for connecting parts, comprising the steps of
providing a first part,
providing a second part,
subjecting said first part to torsional ultrasonic vibrations, wherein
at least one of the parts consists entirely or partially of plastic.

23. A process for connecting parts,
comprising the step of
subjecting a part to torsional ultrasonic vibrations, wherein
at least one part contains a shock-sensitive component, or
at least one part is associated with a shock-sensitive component.

24. The process as claimed in claim 23, wherein the component is an element of the group comprising
an electronic component; a gas; a fluid; a fine-mechanical component; a chemical compound; a substrate for conductor tracks; a treated surface; a plastic element with thin walls; riveted joints; hard and breakable materials.

25. The process as claimed in claim 22, wherein the parts form an at least partially closed housing of plastic after connecting.

26. The process as claimed in claim 24, wherein said electronic component is a sensor.

27. The process as claimed in claim 22, comprising the step of connecting the parts to one another along a contour that is not rotationally symmetrical.

28. A process for riveting, comprising the steps of
providing a first molding having at least one molding pin and providing a second molding and
subjecting the molding pin to torsional ultrasonic vibrations in such a way as to produce a deformation of the molding pin into a rivet head and
connecting the two moldings.

29. The process as claimed in claim 22,
comprising the step of
fixing said part or molding relatively with respect to the direction of movement and direction of oscillation of a sonotrode in a molding holder, wherein
the part or molding to be connected is not directly subjected to oscillations.

30. A device for torsional ultrasonic welding comprising
a generator,
at least one converter and
a torsional oscillator for subjecting a sonotrode to torsional oscillations, and
a molding holder for clamping a molding,
wherein
said molding holder is formed in such a way that a molding is fixable with substantially no play in relation to torsional and longitudinal directions of movement of the sonotrode in the molding holder in such a way that a welded connection is achievable.

31. The device as claimed in claim 30, wherein said molding holder comprises a casting of a molding and/or a clamping holder.

32. The device as claimed in claim 30, wherein the molding is fixable in said molding holder in such a way that the molding holder directly borders a plane of a weld to be formed, or protrudes at least partially beyond the plane of the weld.

33. A process for fine stamping and/or fine lapping a molding, comprising the step of
subjecting a surface of the molding to be worked to torsional oscillations.
